(19) United States
(12) Patent Application Publication
(10) Pub. No.: US 2026/0106864 A1
(43) Pub. Date: Apr. 16, 2026

(54) TRAINING AN ENSEMBLE OF MODELS

(71) Applicant: Telefonaktiebolaget LM Ericsson (publ), Stockholm (SE)

(72) Inventors: Konstantinos VANDIKAS, Solna (SE); Máté SZEBENYEI, Budapest (HU); Abdulrahman ALABBASI, Kista (SE); Alexandros PALAIOS, Herzogenrath (DE); Athanasios KARAPANTELAKIS, Solna (SE); Roy TIMO, Kungssängen (SE)

(73) Assignee: Telefonaktiebolaget LM Ericsson (publ), Stockholm (SE)

(21) Appl. No.: 19/117,243

(22) PCT Filed: Mar. 8, 2023
(86) PCT No.: PCT/EP2023/055882

§ 371 Date: Mar. 31, 2025

(30) Foreign Application Priority Data
Oct. 6, 2022 (GR) 20220100821

(51) Int. Cl. H04L 9/40; G06N 20/20

(52) U.S. Cl. CPC H04L 63/0823; G06N 20/20

(57) ABSTRACT

A method for enabling a model trainer to train a model. The method includes transmitting a first certificate request message to an endpoint associated with a first secure enclave. The method also includes receiving a first certificate response message responsive to the first certificate request message, wherein the first certificate response message comprises a first certificate generated by the first secure enclave and a first digital signature generated by the first secure enclave for authenticating the first certificate. The method also includes determining whether the first certificate is valid. The method also includes, as a result of determining that the first certificate is valid, transmitting to the endpoint or to the model trainer a model information message comprising information pertaining to the model.

### TECHNICAL FIELD

Disclosed are embodiments related to model training.

### BACKGROUND

A multi-vendor autoencoder for channel state information (CSI) compression includes an encoder module and a decoder module. A key challenge when training a multi-vendor autoencoder for CSI compression is that of revealing the architecture of the encoder model and decoder model. This is a particularly sensitive subject since in CSI compression the encoder model is trained on a user equipment (UE) provided by one vendor (encoder part of the model) and the decoder module is trained on a network device provide by another vendor, or, alternatively the models are trained by a trainer running on a cloud service. In either case, neither vendor is interested in revealing the inner workings of their respective model (e.g., architecture of the model) because their model is proprietary and each party has likely invested a significant amount of time and other resources to produce their model and their model is expected to bring revenue either via licensing or simply by outperforming the competitors model. In addition, it is also important to conceal any message exchanges (e.g., transmission of gradients) that might take place between the encoder part and the decoder part (and vice versa) while the models are being trained because that information can provide hints that might reveal the encoder model's and/or decoder model's architecture (e.g., by making use of generative models).

An overview of CSI compression model training process across different vendors is shown in FIG. 1. The channel data source (CDS) has training data (H) that is provided to both the encoder model (or “encoder” for short) and the network (NW) controlled training service, which includes a decoder. The encoder encodes H (e.g., encodes or compresses H) to produce encoded data Y which is then transmitted to the decoder. The decoder takes Y as input and decodes Y (e.g., decodes or decompresses Y) to produce A. Because the training service is provided with H and produces A the training service can use this data and a loss function to provide to the encoder side gradients and L (i.e., data representing the difference between H and H), which are then used by the encoder side to update the weight values and bias values of the encoder model.

### SUMMARY

Certain challenges presently exist. For instance, techniques such as homomorphic encryption (HE) can be used to conceal the gradients exchanged during the process of forward/backward propagation thus allowing each party to operate on encrypted content instead of directly revealing the model's architecture, but, due to the computational complexity of HE, only partial homomorphic encryption is applicable in practice, which means that only certain operations can be supported (i.e., additive or multiplicative HE) and for a limited number of iterations. In addition, the application has to be re-implemented to consider HE constructs and also a communication loop/protocol between the involved parties.

Multi-party computation (MPC) techniques are an alternative solution to the same problem, but MPC techniques scale poorly to the number of participants and require a large amount of signaling, which can be problematic in a multi-vendor setup.

The use of secure enclaves (e.g., Intel's Software Guard Extensions (SGX)) is a promising approach to address the problem of concealing model architectures. Secure enclaves propose a computer architecture that complements a first CPU with a second CPU that is only allowed to access an encrypted memory space that the first CPU cannot access. The first CPU is allowed to transfer a process to the secure enclave, but while that process is running in the enclave no other process (running on the first CPU) has access to that. This is based on the assumption that the enclave's manufacturer and the provider of the operating system have implemented secure enclave properly. Still, what is lacking is a mechanism that describes how this process can be orchestrated between multiple parties in the context of a session, and how the different parties can gain trust that the models are trained properly while being concealed.

Accordingly, in one aspect there is provided a method for enabling a model trainer to train a model. The method includes transmitting a first certificate request message to an endpoint associated with a first secure enclave. The method also includes receiving a first certificate response message responsive to the first certificate request message, wherein the first certificate response message comprises a first certificate generated by the first secure enclave and a first digital signature generated by the first secure enclave for authenticating the first certificate. The method also includes determining whether the first certificate is valid. The method also includes, as a result of determining that the first certificate is valid (i.e., determining that the trainer running in the enclave), transmitting to the endpoint or to the model trainer a model information message comprising information pertaining to the model.

In another aspect there is provided a method for enabling a model trainer to train an ensemble of models comprising a first model and a second model. The method includes receiving from a first remote party a first certificate request message. The method also includes transmitting a first certificate response message responsive to the first certificate request message, wherein the first certificate response message comprises a certificate generated by a secure enclave in which the model trainer runs and a digital signature generated by the secure enclave for authenticating the certificate. The method also includes after transmitting the first certificate response message, receiving a first model information message transmitted by the first remote party, the first model information message comprising information pertaining to the first model. The method also includes receiving from a second remote party a second certificate request message. The method also includes transmitting a second certificate response message responsive to the second certificate request message, wherein the second certificate response message comprises the certificate generated by the secure enclave and the digital signature generated by the secure enclave. The method also includes, after transmitting the second certificate response message, receiving a second model information message transmitted by the second remote party, the second model information message comprising information pertaining to the second model.

In another aspect there is provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium. In another aspect there is provided a network node that is configured to perform the methods disclosed herein. The network node may include memory and processing circuitry coupled to the memory.

An advantage of the embodiments disclosed herein is that they allow for training ensembles (e.g., pairs) of different machine learning (ML) models originating from different administrative domains while concealing their architecture from parties which are not allowed to be exposed to that but still need a counterpart model to train against their own. The embodiments can be applied in a variety of use cases, including split encoder/decoder architectures, autoencoders, and generative adversarial networks (GANs) where the generator and the discriminator are coming from different administrative domains.

### BRIEF DESCRIPTION OF THE DRAWINGS

The accompanying drawings, which are incorporated herein and form part of the specification, illustrate various embodiments.

FIG. 1 illustrates a system comprising an encoder and a decoder.

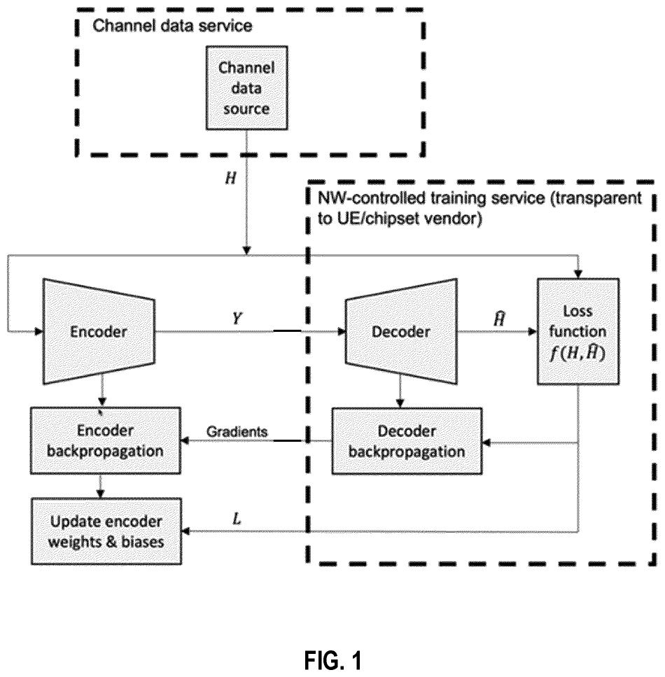

FIG. 2 illustrates a cloud-based system according to an embodiment.

FIG. 3 illustrates a non-cloud based system according to an embodiment.

FIG. 4A is a message flow diagram according to an embodiment.

FIG. 4B is a message flow diagram according to an embodiment.

FIG. 5A is a message flow diagram according to an embodiment.

FIG. 5B is a message flow diagram according to an embodiment.

FIG. 6 is a message flow diagram according to an embodiment.

FIG. 7 is a flowchart illustrating a process according to an embodiment.

FIG. 8 is a flowchart illustrating a process according to an embodiment.

FIG. 9 is a block diagram of a network node according to an embodiment.

### DETAILED DESCRIPTION

To conceal the architecture of the individual models with a set of models (a.k.a., ensemble) (e.g., an encoder model and decoder model), this disclosure proposes using a secure enclave (SE) for training the different parts of the ensemble, which may originate from one or more vendors (e.g., (UE chipset vendor and a telecommunication equipment vendor).

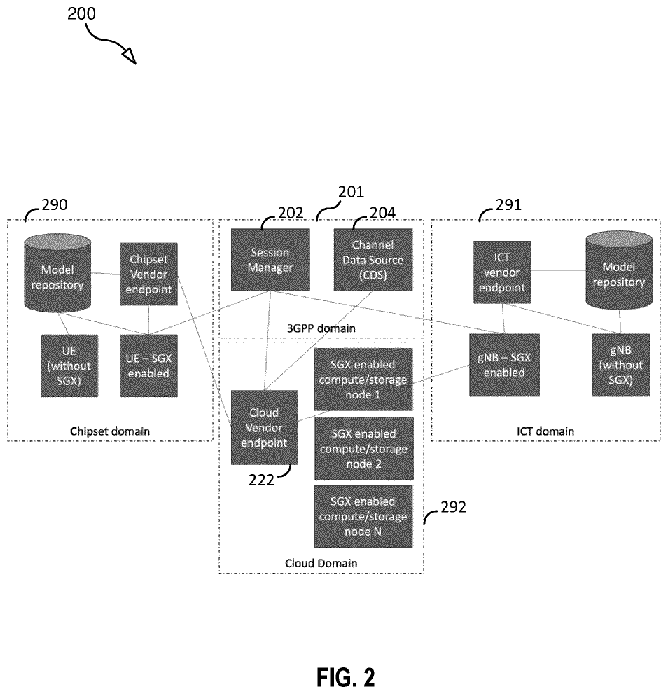

A system according to one embodiment is shown in FIG. 2. As shown in FIG. 2, system 200 includes four administrative domains: (1) a neutral domain 201 (e.g., 3GPP Domain); (2) a chipset domain 290; (3) an Information and Communication Technology (ICT) domain 291; and (4) a cloud domain 292.

### Neutral Domain

The neutral domain is a neutral administrative domain trusted by everyone and, in some embodiments, standardized by 3GPP (hence, the neutral domain is sometimes referred to as the 3GPP domain). The neutral domain includes: a channel data source (CDS) 204, i.e., the data source providing data that can be used for training the different models and a session manager 202, which is responsible for initiating the different training sessions among multiple participants.

### Chipset Domain

The chipset domain 290 is specific to a UE chipset designer (or manufacturer) and is associated with four types of nodes: 1) a model repository where the different models are stored (in this case the encoders); 2) SE enabled UEs; 3) non-SE enabled UEs; and 4) an endpoint, which can be used for exchanging messages with other interfaces in order to participate in the process of training an encoder model (or “encoder” for short) with a decoder model (or “decoder” for short). In one embodiment, an SE enabled UE is a UE implementing Intel Software Guard Extensions (SGX), which is an Intel technology for application developers who are seeking to protect select code and data from disclosure or modification. Further information regarding Intel SGX can be found at:
www (dot) intel (dot) com/content/dam/develop/external/us/en/documents/overview-of-intel-sgx-enclave-637284.pdf. A non-SE enabled UE can still obtain an encoder from the local model repository, but the on-SE enabled UE cannot participate in the model training process.

### ICT Domain

The ICT domain (or telecommunication domain) is specific to the telecommunication area which is tasked to train the decoders while concealing the decoder's architecture. This domain is associated with four types of nodes: 1) a model repository where the different models are stored (in this case the decoders); 2) SE enabled access network node (e.g., an SE enabled 4G base station (denoted eNB) and/or a 5G base station (denoted gNB)); 3) non-SE enabled access network nodes; and 4) an endpoint, which can be used for exchanging messages with other interfaces in order to participate in the process of training an encoder with a decoder.

### Cloud Domain

The cloud domain represents a cloud infrastructure, which includes a cloud vendor endpoint that is used to exchange messages with the cloud infrastructure which consists of one or more servers which will be used to train the encoder/decoder pairs. The servers of the cloud infrastructure may be SE enabled (e.g., SGX enabled) or not.

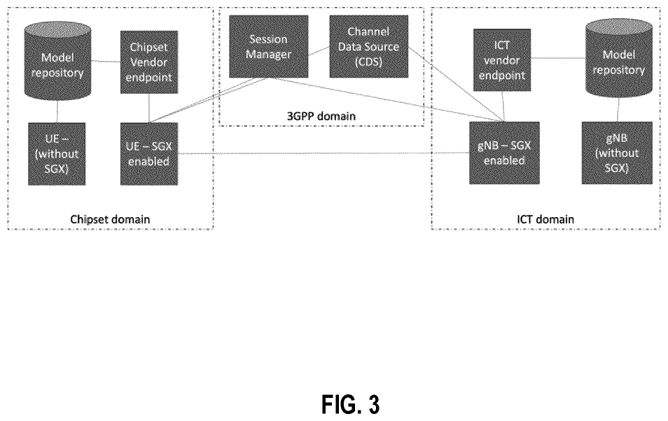

The cloud domain is optional, as illustrated in FIG. 3. That is, the process of training a model ensemble (e.g., encoder/decoder pair) can take place without the cloud domain by allowing one or more SE enabled UEs and SE enabled access network nodes of the ICT domain perform the training.

The embodiments rely on remote attestation. The purpose of remote attestation is to verify that there is a process (e.g., a process for training an autoencoder (AE), which process is referred to as “AE Trainer” or simply “AET” for short) running inside a secure enclave and not in another type of central processing unit (CPU) or infrastructure. Remote attestation provides trust either to the telecom vendor (e.g., vendor of base station) or to the UE chipset vendor that once they transmit the model architecture information pertaining to their model, the information will not be intercepted by any other process which may manipulate it or copy it.

This type of assurance is very much tied to the hardware implementation of the secure enclave and also to the software components that implement the access to that hardware. In other words, any weaknesses or attacks that can be performed on that level are beyond the scope of this disclosure. Therefore, it assumed herein that secure enclaves are indeed secure.

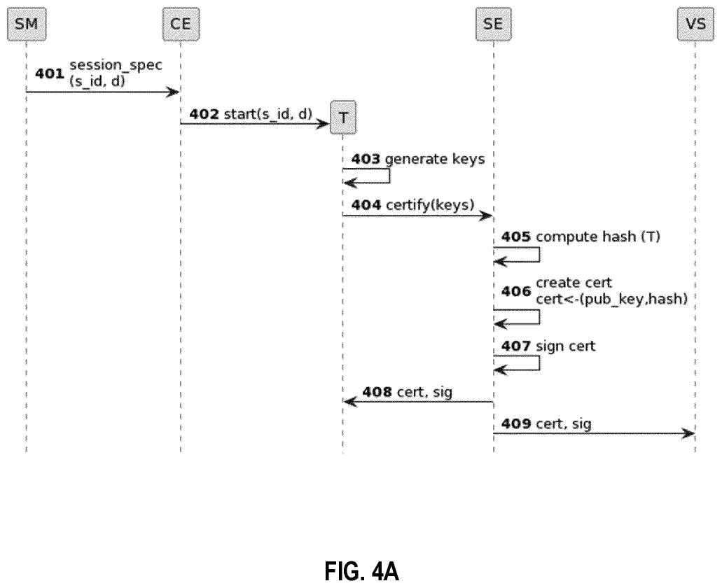

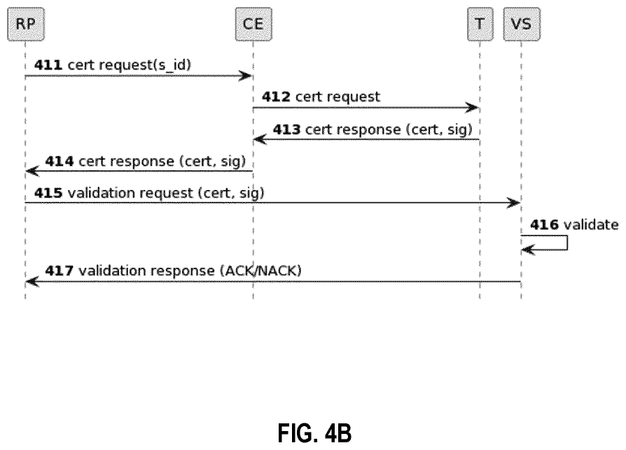

FIGS. 4A and 4B illustrate a generic remote attestation process. The process includes two phases: a bootstrapping phase (see FIG. 4A) and a remote attestation phase (see FIG. 4B).

### Bootstrapping Phase

Step 401: The process begins when the session manager (SM) issues a session specification which contains a session identifier (s_id) for this training process and may also include the expected duration (d) which signifies for how long the session will be valid. This message is received by a cloud endpoint (CE) which resides in the cloud domain.
Step 402: The CE creates a model trainer (or “trainer (T)” for short) for the given session to run inside a secure enclave (SE) that has been tasked to support this process. The trainer (which could be tensorflow or pytorch or some other machine learning application) is expected to train the model ensemble as soon as the needed and split architectures (e.g., encoder originating from the UE vendor and decoder originating from the ICT vendor) are communicated.
Step 403: As part of the remote attestation process the trainer needs to prove that it is running inside a secure enclave. To that end, the trainer application while running inside the SE obtains (e.g., generates or receives) a key pair (i.e., a public key and a corresponding private key) for the given session and for the expected duration.
Step 404: The trainer provides the key pair (or just public key) to the SE to be certified by the SE.
Step 405: The SE computes a hash for the given session and duration. Among other things, the hash is expected to capture specific aspects of the SE such as its operation system, PCR structure, and memory space. In one embodiment, an input to the hash function is the binary image of the trainer software.
Step 406: The secure enclave creates a certificate which contains T's public key and the hash.
Step 407: The SE uses its private key to “sign” the certificate, thereby creating a digital signature (a.k.a., “signature (sig)” for short) associated with the certificate and the SE's private key. Step 408: The SE sends to the trainer the certificate (cer) and the signature (sig). The trainer will use the cert and sig in the remote attestation process to prove to others that it is indeed running inside the SE.
Step 409: The SE sends to a verification server (VS) a message containing the cert and sig so that the VS can store in a verification database a record containing the cert and sig. This database record will be used by external remote parties to verify that the trainer is running inside the SE. Remote Attestation Phase (see FIG. 4B)
Step 411: When a remote party (RP) (e.g., endpoint within chipset domain, CDS 204, and/or endpoint in ICT domain) needs to perform remote attestation for a given trainer that is running inside an SE the RP sends to the CE a certificate request, which asks for the remote attestation process to begin.
Step 412: The CE responds to the certificate request by sending a certificate request to the trainer that is running inside the SE.
Step 413: The trainer responds with the cert and sig it received previously in step 408.
Step 414: The cert and sig is then sent to the RP in a certificate response message.
Step 415: In one embodiment, as shown in FIG. 4B, the RP sends to the VS a validation message containing the cert and sig, thereby requesting the VS to validate the cert and sig.
Step 416: The VS verifies that certificate is valid (e.g., the signature received matches a generated signature, and the certificate has not expired).
Step 417: The VS sends to the RP a positive acknowledgment (ACK) if the certificate is determined to be valid, otherwise VS sends to RP a negative ACK (NACK). In some embodiments, after the duration (or expiration date) of the certificate, VS may remove the certificate from the verification database.

In some embodiments, steps 415-417 are not performed, but instead the RP itself validates the cert by using the public key of the SE to generate a signature of the received cert and then compares the generated sig with the received sig to determine whether they are identical. If they are identical, then the RP will trust that the cert originated from the SE.

The above example illustrates one-way attestation (i.e., the RP determines whether or not the trainer is running in an SE). In the same manner this can be extended to a two-way attestation (i.e., the trainer can determine whether the RP is running in an SE). In this way, one can establish that, for example, the application that is providing the model to be trained is also running inside an SE. The benefit of this is that it reduces the chances that another process might corrupt the input architecture because that is now coming from an encrypted memory space where other processes lack access.

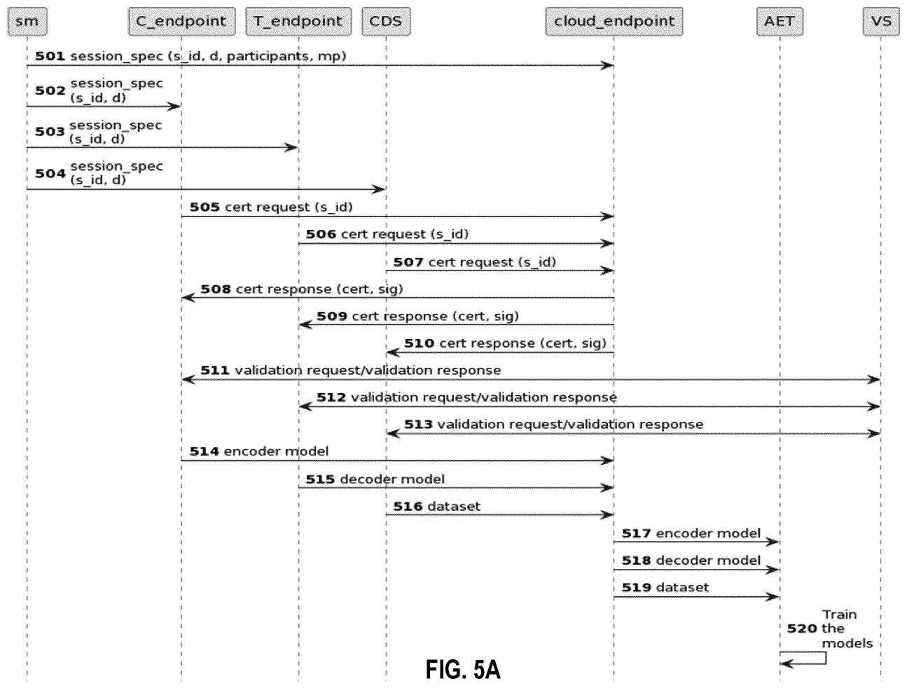

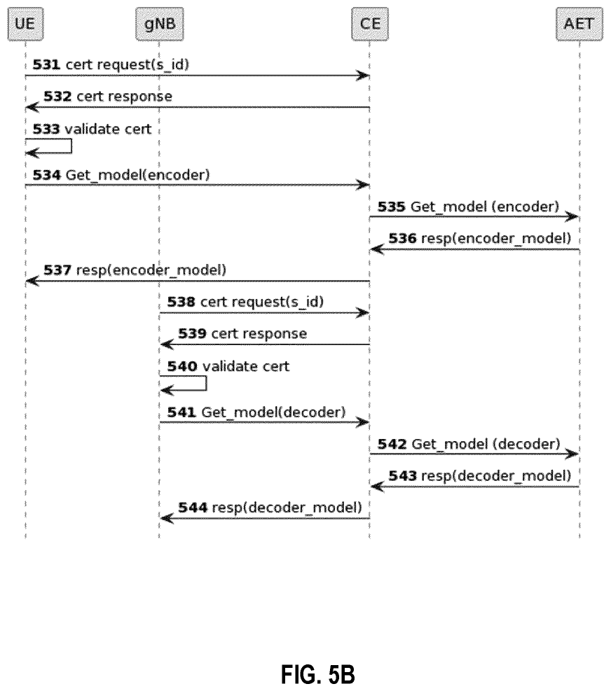

FIG. 5A illustrates a specific use case where the trainer is an autoencoder trainer (AET) running in an SE within the cloud domain. The AET is configured to train an encoder model provided by a first vendor (e.g., a UE vendor or a chipset vendor) and a decoder model provided by a second vendor (e.g., an ICT vendor, such as a base station vendor).

The process begins with an SM distributing a session specification to the various entities involved in the training of the models (see steps 501-504). The session specification includes a unique session identifier (s_id) and may include a list of participants (e.g., a list of endpoints) and a model pairings structure that defines which model should be trained along with which other model and in what way. An example model pairings structure contains the following information:
Participant1.encoder.with(Participant2.decoder)->p12.autoencoder
Participant2.encoder.with(Participant3.decoder)->p23.autoencoder.

A model pairing structure is used to determine which participants (e.g., which vendors) are to participate in the session and which part of the model the vendor will provide (e.g., encoder or decoder). In this case, a simple Object oriented syntax is employed to describe this process which includes binary operators such as_with_to combine one or models and then optionally produce a single named model as a result. Other formal approaches or types of syntax can be employed for the same purpose.

The next phase (steps 505-513) involves each remote party (i.e., endpoint in the chipset domain (C_endpoint), endpoint in the ICT domain (T_endpont), and the CDS) verifying that the AET is indeed running in an SE. That is, each remote part performs the remote attestation process shown in FIG. 4B (it can be assumed that the steps of the bootstrapping phase in FIG. 4A have already taken place). That is each remote part sends to the endpoint in the cloud domain (cloud_endpoint) a certificate request comprising the session id (steps 505, 506, and 507). The cloud endpoint responds to each request with a certificate response containing the requested certificate (steps 508, 509, and 510). Each remote party after receiving the certificate response validates the certificate. In this example, each remote party uses the validation server (VS) to validate the certificate (steps 511, 512, and 513).

Assuming each remote part determines that the certificate is valid, then: i) the C_endpoint sends to cloud_endpoint a model information message comprising information pertaining to the encoder (step 514), ii) the T_endpoint sends to cloud_endpoint a model information message comprising information pertaining to the decoder (step 515), and iii) the CDS sends to cloud_endpoint a model information message comprising the training dataset needed for this training process (step 516). In one embodiment, information pertaining to a model includes: information indicating the number of layers in the model, information indicating the number of neurons per layer, information specifying an activation function, model weight values, and/or model bias values.

In one embodiment, the contents of each model information message is encrypted in such a way that only the AET can decrypt the content of the message (or, more precisely, only an entity in possession of AET's private key can decrypt the content of the message). For example, reach remote party may encrypt the content using the public key belonging to the AET, which public key is include in the cert. In this case, the AET can simply use it private key to decrypt the contents of the message. Alternatively, each remote party may encrypt the content of the model information message that it creates and sends to the cloud endpoint using a secret symmetric key, encrypting the secret symmetric key using AET's public key, and including in the model information message the encrypted version of the secret symmetric key. The AET can obtain the secret symmetric key by using its private key to decrypt the encrypted version. Once the AET obtains the symmetric key, it can use the symmetric key to decrypt the remaining contents of the model information message.

In the case where there are more participants, this process continues until every participant has signed up. To avoid the case of delayed arrivals or the case when a participant does not show up at all a timeout can be optionally specified in the session_spec to make sure that participants proceed with the session establishment phase timely.

Optionally, there can also be a two-way attestation. That is, before receiving the model information messages from each remote party, the AET determines that the remote party is also running in a secure enclave using the same process as shown in FIG. 4A and FIG. 4B.

### Training Phase

The cloud_endpoint provides to the AET the information pertaining to the encoder (e.g., information identifying the architecture, weights and bias values of the encoder), the information pertaining to the decoder (e.g., information identifying the architecture, weights and bias values of the decoder), and the training dataset (steps 517, 518, and 519).

Once AET has the model information and training dataset, the AET can perform the conventional model training process (step 520). Because the model is an autoencoder the process begins by producing a latent representation for every batch in H which is named latent_space. Latent_space is then sent to the decoder which attempts to decode it and produces H\hat{ } for that specific batch. The loss between H and H\hat{ } is calculated and the decoder back propagates and then sends the gradients back to the encoder for the encoder to back propagate. The process continues until all batches have been processed.

### Deployment Phase

After the models are trained, the models need to be deployed. An example deployment phase is shown in FIG. 5B, which shows the encoder being deployed to a user equipment (UE) and the decoder being deployed to a base station (e.g., a 5G base station (gNB)). Alternatively, the encoder may be provided to the C_endpoint, which then stores the encoder in the model depository in the chipset domain, and the decoder provided to the T_endpoint, which then stores the decoder in the model depository in the ICT domain. The process is exactly the same whether the encoder is deployed to UE or C_endpoint or whether the decoder is deployed to the gNB or T_endpoint. That is, with respect to FIG. 5B one can just replace “UE” with “C_endpoint” and “gNB” with “T_endpoint.”

As shown in FIG. 5B, the deployment phase may begin with the UE verifying that the AET that has the encoder is in the SE. That is, for example, i) the UE sends a certificate request with the session id to the CE (a.k.a., cloud_endpoint) (step s531), ii) the CE responds by sending to the UE a certificate response containing the cert and sig associated with the session id (step 532) (as shown in FIG. 4B, CE may obtain the cert and sig from the AET), iii) the UE validates the cert and sig (step 533) (e.g., the UE may use the VS to validate the cert as shown in FIG. 4B). After the cert is verified, the UE sends to the CE a “Get_model” request indicating that the UE is requesting the encoder (step 534), and the CE retrieves the encoder from the AET (step 535 and 536) and then provides the encoder to the UE in a response message (step 537).

The gNB performs the same steps as the UE. That is, for example, i) the gNB sends a certificate request with the session id to the CE (step 538), ii) the CE responds by sending to the gNB a certificate response containing the cert and sig associated with the session id (step 539), iii) the gNB validates the cert and sig (step 540) (e.g., the gNB may use the VS to validate the cert as shown in FIG. 4B). After the cert is verified, the gNB sends to the CE a “Get_model” request indicating that the gNB is requesting the decoder (step 541), and the CE retrieves the decoder from the AET (step 542 and 543) and then provides the decoder to the gNB in a response message (step 544).

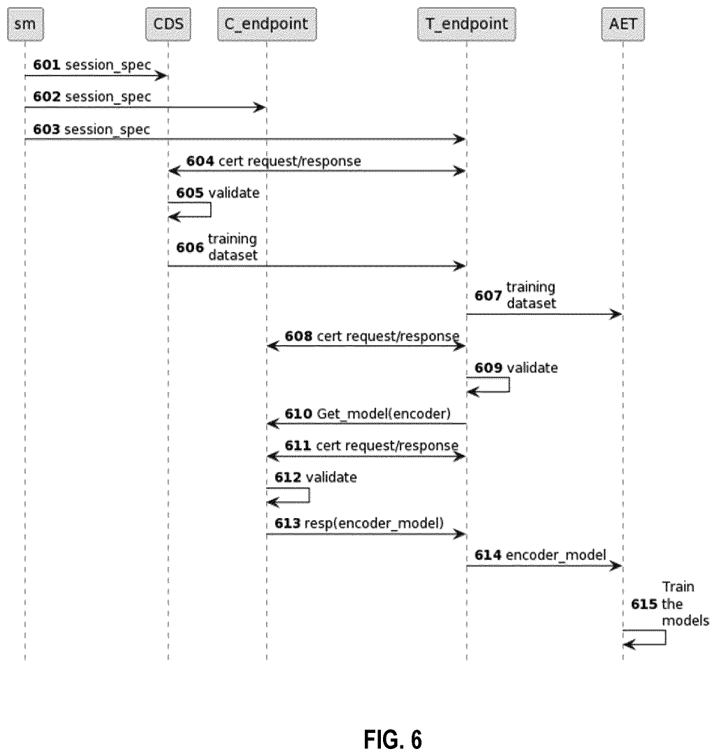

In another embodiment, training that conceals the architecture of the models can be achieved without using the cloud domain. For instance, a trainer in either the chipset domain or the ICT domain can perform the training in a secure manner that conceals the architecture of the models. Such an embodiment is illustrated in FIG. 6. In this example, the training occurs in the ICT domain, but the process is the same if the training were to occur in the chipset domain.

The process begins with an SM distributing a session specification to the various entities involved in the training of the models (see steps 601-603). The session specification includes a unique session identifier (s_id).

After receiving the session specification, the CDS performs the remote attestation of the AET. That is, the CDS verifies that the AET that is in the SE. That is, for example, i) the CDS sends a certificate request with the session id to the T_endpoint and ii) the T_endpoint responds by sending to the CDS a certificate response containing the cert and sig associated with the session id (step 604). The CDS then validates the cert and sig (step 605). After the cert is verified, the CDS sends to the T_endpoint a model information message comprising a training dataset (step 606). The T_endpoint then provides the training dataset to the AET (step 607). As noted above, the training dataset included in the model information message may be encrypted.

After receiving the training dataset, the T_endpoint needs to obtain the encoder from the chipset domain. In this example, the T_endpoint first checks that encoder is originating from an application in the chipset domain that is running in an SE. This is needed for the T_endpoint to make sure that it is receiving a valid and non-tampered encoder model from the UE. Hence, the T_endpoint performs the remote attestation process show in FIG. 4A and FIG. 4B. That is, for example, i) the T_endpoint sends a certificate request to the C_endpoint and ii) the C_endpoint responds by sending to the T_endpoint a certificate response containing a cert and sig generated by the SE within the chipset domain (step 608). After receiving the certificate response, the T_endpoint determines whether the cert is valid (e.g., as shown in FIG. 4B, T_endpoint may provide to the VS a validate message comprising the cert and sig).

Assuming the cert is valid, the T_endpoint sends to the C_endpoint “Get_model” message for the encoder (step 610). However, before the C_endpoint retrieves the model from the application in the chipset domain to provide to the T_endpoint, the C_endpoint performs the remote attestation process to determine that the AET is in an SE. That is, i) the C_endpoint sends a certificate request to the T_endpoint and ii) the T_endpoint responds by sending to the C_endpoint a certificate response containing a cert and sig generated by the SE in which the AET is running (step 611). After receiving the certificate response, the T_endpoint determines whether the cert is valid (step 612) (e.g., as shown in FIG. 4B, T_endpoint may provide to the VS a validate message comprising the cert and sig). After receiving the certificate response, the C_endpoint determines whether the cert is valid (e.g., as shown in FIG. 4B, C_endpoint may provide to the VS a validate message comprising the cert and sig it received from the T_endpoint).

Assuming the cert is valid, the C_endpoint obtains the information pertaining to the encoder (e.g., obtains this encoder information from the application running in the SE in the chipset domain) and sends to the T_endpoint a model information message comprising the information pertaining to the encoder (step 613). T_endpoint then sends this model information to AET (step 614) (as noted above, this model information may be encrypted such that only AET is able to decrypt the information). The AET then performs the training process, which is the same as described previously with respect to FIG. 5A.

After the models are trained, the trained decoder may be provided to the model repository in the ICT domain and the trained encoder may be provided to C_endpoint which then stores the trained model in the model repository in the chipset domain

### Optimization of Network Versus Enclaved Training

To further complement the aforementioned embodiments we propose a decision mechanism which determines different placement of training functions. More specifically, In another embodiment of the main flow chart explained in FIG. 5, we propose to capture the case where enclaving has two limitations: 1) requires considerable time (in relation to online training tasks) and 2) limited physical resource for enclaving.

Given the above considerations (or limitation) for enclave training (of course they also exist for conventional training, but may be with lower strictness depending on resources), we can consider more realistic (or complicated) scenario, where the training service requester declares that there are two groups of layers within its models. Group-S which requires that a layer has high security that is achieved via enclaving. Group-C, which can be considered as common layer among vendors, and does not requires such strict security as in Group-S, but requires faster training and better convergence. In this embodiment, Group-S is assumed to be trained at the remote enclave server, while Group-C could be trained at either at the remote enclave server or locally over the air between two non-enclaved gNB and UE. Therefore, we aim to make an educated decision on whether to train layers belonging to Group-C at the enclave server or locally in the network domain (i.e., among UE and gNB, note that below, we call the network training between UE and gNB as local training, which is local in compared to the enclaved training) we follow these steps:
S1—Send a message from the session manager to the remote enclave server inquiring about available resources (call it R_E, could be CPUs or RAM or other hardware resources) and required time for specific size of model and data training (call it T_E).

S2—Session manager sends a message to the local AI agent (either at UE or gNB), inquiring about available resources (call it R_L) and required time for specific size of model and data training (call it T_L), in addition to the time required to copy the data to the remote enclave server.
S3—Both remote and local enclaved (or non enclaved) AI-Agent servers responds to session manager with those messages, R_E, T_E and R_L, T_L, respectively.
S4—The session manager considers the following parameters to decide on whether to train in the enclave or local agent. Normalized Parameters (e.g., normed via max value):
   i—R_L and T_L
   ii—R_E and T_E
   iii—T_R required time for training based on the requested training service, if it is online training then T_R is very small, if it is offline training, then T_R is large. W_{T}_{_{R}} is the corresponding weight of the time requirement. Note that I_{T}_{_{R}}{T_{X}<T_{R}} is an indicator function that compares training time locally (or remote) enclaved versus required training time (requested by the AI-Agent), and result in 1 if local training (or remote) enclaved time is less that requested training time. Note that similar definition of enclaved server by changing symbols, where x ∈{L, E}
   iv—w_{S} (or Imp_S), i.e Importance of secure training of such data and model. In some scenarios, the security of some part of the model (i.e. initial layers of a model or certain regions) can be compromised to gain speed of training. In such scenario, w_{S} can be reduce security (allow part of the model to train in a non-enclaved CPU) to allow for higher W_{T}_{_{R}} and potential the model to be placed in faster/available training devices
   v—ρ is The probability of new agent requesting enclaved training (or call it interarrival rate of new enclaved training tasks) within T_x (i.e., probability of increase services queue. Note that

$${w}_{ρ} {I}_{ρ} \{ \frac{{R}_{x}}{{T}_{x}} > ρ \}$$

is another important part of the utility function which measures the local (or remote) enclaved server capability to service the requested training with time T_{L} (or T_{E}) given available resource R_{L} (or R_{E}) and compared to the interarrival time of new service (φ to garuantee stability of the servers.

The Decision function could be a simple maximum utility selection scheme used to decide on whether to train on local or remote enclaved servers, e.g.:

$$Train\_Location = arg max \{ \frac{{w}_{{T}_{L}}}{{T}_{L}} + {W}_{{R}_{L}} {R}_{L} + {w}_{{T}_{R}} {I}_{{T}_{R}} \{ {T}_{L} < {T}_{R} \} + {w}_{ρ} {I}_{ρ} \{ \frac{{R}_{L}}{{T}_{L}} > ρ \} , \frac{{w}_{{T}_{E}}}{{T}_{E}} + {W}_{E} {R}_{E} + {w}_{{T}_{R}} {I}_{{T}_{R}} \{ {T}_{E} < {T}_{R} \} + {w}_{ρ} {I}_{ρ} \{ \frac{{R}_{E}}{{T}_{E}} > ρ \} \} .$$

If first term was larger than second term, then training is conducted locally (among UE and gNB) otherwise, training is done in the enclaved server.

### Open Radio Access Network (ORAN)

From an ORAN perspective the different processes that train the encoder and the decoder can be implemented as “rApps.” An rAPP as a process can also be executed inside a secure enclave therefore the sequence diagram described previously can be slightly modified to target corresponding rAPP processes owned either by the UE or the chipset vendor.

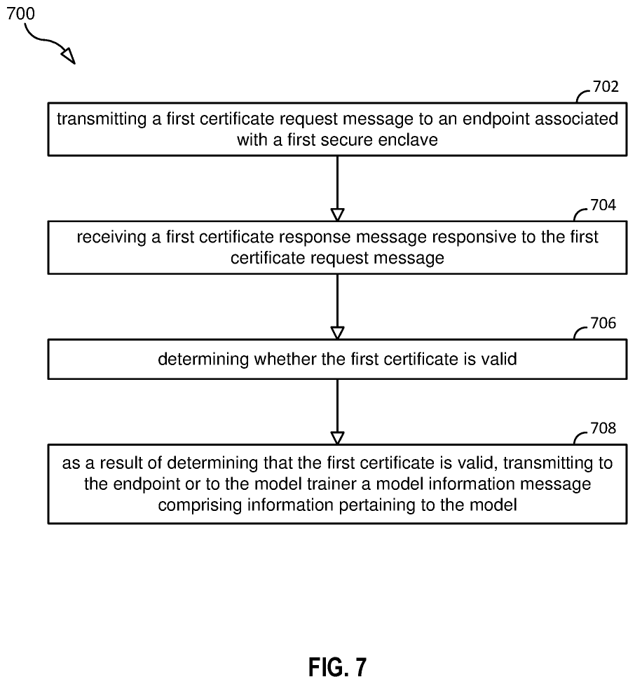

FIG. 7 is a flow chart illustrating a process 700, according to an embodiment, for enabling a model trainer to train a model. Process 700 may begin in step 702.
Step 702 comprises transmitting a first certificate request message to an endpoint associated with a first secure enclave.
Step 704 comprises receiving a first certificate response message responsive to the first certificate request message, wherein the first certificate response message comprises a first certificate generated by the first secure enclave and a first digital signature generated by the first secure enclave for authenticating the first certificate.
Step 706 comprises determining whether the first certificate is valid.
Step 708 comprises, as a result of determining that the first certificate is valid, transmitting to the endpoint or to the model trainer a model information message comprising information pertaining to the model (e.g., the training dataset and/or model architecture).

In some embodiments, the first certificate comprises: a public key belonging to the model trainer and a hash generated by the first secure enclave.

In some embodiments, the model information message is transmitted to the endpoint, the information pertaining to the model is encrypted, and, the information pertaining to the model comprises: information indicating the number of layers in the model, information indicating the number of neurons per layer, information specifying an activation function, model weight values, and/or model bias values.

In some embodiments, the model information message is transmitted to the model trainer, and the information pertaining to the model comprises: information indicating the number of layers in the model, information indicating the number of neurons per layer, information specifying an activation function, model weight values, and/or model bias values

In some embodiments, the first certificate response message comprises the address (e.g., IP address or domain name, such as a Fully Qualified Domain Name (FQDN)) of the model trainer.

In some embodiments the process also includes, prior to transmitting the first certificate request message, receiving from a session manager a session initiation message comprising a session identifier. In some embodiments, the first certificate request message comprises the session identifier.

In some embodiments, the method is performed by a chipset vendor, or the method is performed by a telecommunication equipment vendor.

In some embodiments, determining whether the certificate is valid comprises: transmitting to a validation server a validation request message comprising the certificate and the signature; and receiving a verification response message responsive to the verification request message, wherein the certificate response message comprises information indicating whether or not the certificate is valid.

In some embodiments the process also includes, prior to transmitting the first certificate request message, receiving a second certificate request message transmitted by the endpoint; in response to receiving the second certificate request message, transmitting to the endpoint a second certificate response message responsive to the second certificate request message, wherein the second certificate response message comprises a second certificate generated by a second secure enclave and a second digital signature generated by the second secure enclave for authenticating the second certificate; and after transmitting the second certificate response message, receiving from the endpoint a model information request message, wherein the first certificate request message is transmitted to the endpoint in response to receiving the model information request message.

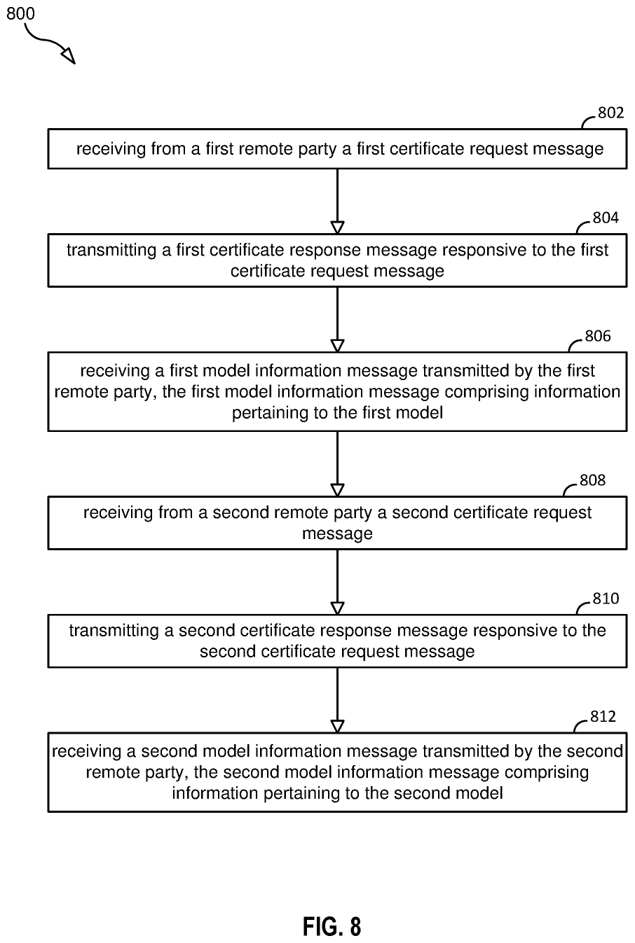

FIG. 8 is a flow chart illustrating a process 800, according to an embodiment, for enabling a model trainer to train an ensemble of models comprising a first model and a second model. Process 800 may begin in step 802.
Step 802 comprises receiving from a first remote party a first certificate request message.
Step 804 comprises transmitting a first certificate response message responsive to the first certificate request message, wherein the first certificate response message comprises a certificate generated by a secure enclave in which the model trainer runs and a digital signature generated by the secure enclave for authenticating the certificate.
Step 806 comprises after transmitting the first certificate response message, receiving a first model information message transmitted by the first remote party, the first model information message comprising information pertaining to the first model.
Step 808 comprises receiving from a second remote party a second certificate request message.
Step 810 comprises transmitting a second certificate response message responsive to the second certificate request message, wherein the second certificate response message comprises the certificate generated by the secure enclave and the digital signature generated by the secure enclave.
Step 812 comprises after transmitting the second certificate response message, receiving a second model information message transmitted by the second remote party, the second model information message comprising information pertaining to the second model.

In some embodiments the process also includes providing to the model trainer the information pertaining to the first model; and providing to the model trainer the information pertaining to the second model.

In some embodiments the process also includes the model trainer using the information pertaining to the first model and the information pertaining to the second model to train the first model and the second model. In some embodiments the process also includes providing the trained first model to the first remote party; and providing the trained second model to the second remote party.

In some embodiments the process also includes, prior to receiving the first certificate request message, receiving from a session manager a session initiation message comprising a session identifier; and, in response to receiving the session initiation message, creating the model trainer to run within the secure enclave.

In some embodiments the process also includes, after receiving the first certificate request message and before transmitting the first certificate response message, obtaining the certificate from the model trainer.

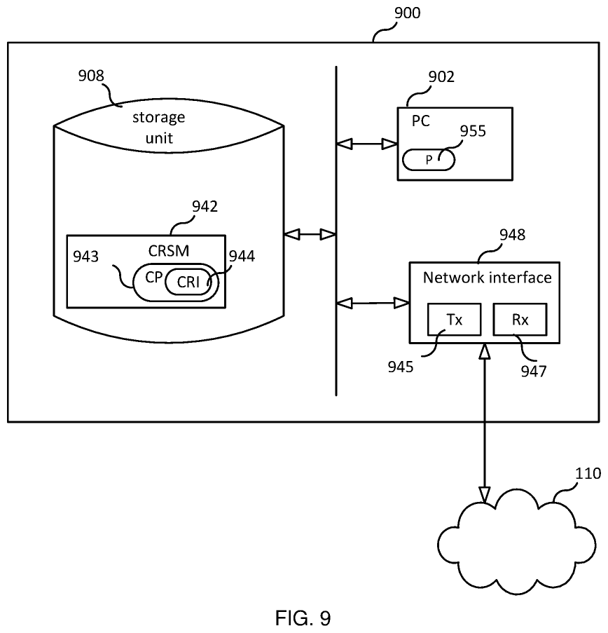

FIG. 9 is a block diagram of network node 900, according to some embodiments. Network node 900 can be used to implement any of the nodes described herein, such as, for example, any of the endpoints described herein, the session manager, the verification server, etc. As shown in FIG. 9, network node 900 may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 900 may be a distributed computing apparatus); at least one network interface 948 (e.g., a physical interface or air interface) comprising a transmitter (Tx) 945 and a receiver (Rx) 947 for enabling network node 900 to transmit data to and receive data from other nodes connected to a network 110 (e.g., an Internet Protocol (IP) network) to which network interface 948 is connected (physically or wirelessly) (e.g., network interface 948 may be coupled to an antenna arrangement comprising one or more antennas for enabling network node 900 to wirelessly transmit/receive data); and a storage unit (a.k.a., “data storage system”) 908, which may include one or more non-volatile storage devices and/or one or more volatile storage devices. In embodiments where PC 902 includes a programmable processor, a computer readable storage medium (CRSM) 942 may be provided. CRSM 942 may store a computer program (CP) 943 comprising computer readable instructions (CRI) 944. CRSM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes network node 900 to perform steps described herein (e.g., steps described herein with reference to the flow charts). In other embodiments, network node 900 may be configured to perform steps described herein without the need for code. That is, for example, PC 902 may consist merely of one or more ASICs. Hence, the features of the embodiments described herein may be implemented in hardware and/or software.

### CONCLUSION

This disclosure provides a way of establishing a session between multiple parties (different administrative domains) for training a set of models (e.g., a model pair comprising an encoder model and a decoder model) without revealing the architecture of each model and delivering the corresponding products (trained models) securely back to the participating devices. In addition, this disclosure provides a decision mechanism that allows the session manager to determine where to place the training of such models also taking into consideration that some layers (or regions) of the model might be public and therefore do not require training inside an enclave but instead can be trained over the air.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for enabling a model trainer to train a model, the method comprising:
transmitting a first certificate request message to an endpoint associated with a first secure enclave;
receiving a first certificate response message responsive to the first certificate request message, wherein the first certificate response message comprises a first certificate generated by the first secure enclave and a first digital signature generated by the first secure enclave for authenticating the first certificate;
determining whether the first certificate is valid; and
as a result of determining that the first certificate is valid, transmitting to the endpoint or to the model trainer a model information message comprising information pertaining to the model.

2-10. (canceled)

11. A method for enabling a model trainer to train an ensemble of models comprising a first model and a second model, the method comprising:
receiving from a first remote party a first certificate request message;
transmitting a first certificate response message responsive to the first certificate request message, wherein the first certificate response message comprises a certificate generated by a secure enclave in which the model trainer runs and a digital signature generated by the secure enclave for authenticating the certificate;
after transmitting the first certificate response message, receiving a first model information message transmitted by the first remote party, the first model information message comprising information pertaining to the first model;
receiving from a second remote party a second certificate request message;
transmitting a second certificate response message responsive to the second certificate request message, wherein the second certificate response message comprises the certificate generated by the secure enclave and the digital signature generated by the secure enclave; and
after transmitting the second certificate response message, receiving a second model information message transmitted by the second remote party, the second model information message comprising information pertaining to the second model.

12-18. (canceled)

19. A computer program comprising instructions which when executed by processing circuitry of a network node causes the network node to perform the method claim 1.

20. A computer program comprising instructions which when executed by processing circuitry of a network node causes the network node to perform the method of claim 11.

21. A network node for enabling a model trainer to train a model, the network node comprising:
a transmitter;
a receiver; and
processing circuitry, wherein the network node is configured to perform a method comprising:
transmitting a first certificate request message to an endpoint associated with a first secure enclave;
receiving a first certificate response message responsive to the first certificate request message, wherein the first certificate response message comprises a first certificate generated by the first secure enclave and a first digital signature generated by the first secure enclave for authenticating the first certificate;
determining whether the first certificate is valid; and
as a result of determining that the first certificate is valid, transmitting to the endpoint or to the model trainer a model information message comprising information pertaining to the model.

22. The network node of claim 21, wherein the first certificate comprises:
a public key belonging to the model trainer; and
a hash generated by the first secure enclave.

23. The network node of claim 21- or 22, wherein
the model information message is transmitted to the endpoint,
the information pertaining to the model is encrypted, and
the information pertaining to the model comprises: information indicating the number of layers in the model, information indicating the number of neurons per layer, information specifying an activation function, model weight values, and/or model bias values.

24. The network node of claim 21- or 22, wherein
the model information message is transmitted to the model trainer, and
the information pertaining to the model comprises: information indicating the number of layers in the model, information indicating the number of neurons per layer, information specifying an activation function, model weight values, and/or model bias values

25. The network node of claim 24, wherein the first certificate response message comprises the address of the model trainer.

26. The network node of claim 21, wherein
the process further comprises, prior to transmitting the first certificate request message, receiving from a session manager a session initiation message comprising a session identifier, and
the first certificate request message comprises the session identifier.

27. (canceled)

28. The network node of claim 21, wherein
the network node is an endpoint of a chipset vendor, or
the network node is an endpoint of a telecommunication equipment vendor.

29. The network node of claim 21, wherein determining whether the certificate is valid comprises:
transmitting to a validation server a validation request message comprising the certificate and the signature; and
receiving a verification response message responsive to the verification request message, wherein the certificate response message comprises information indicating whether or not the certificate is valid.

30. The network node of claim 21, wherein the process further comprises:
prior to transmitting the first certificate request message, receiving a second certificate request message transmitted by the endpoint;
in response to receiving the second certificate request message, transmitting to the endpoint a second certificate response message responsive to the second certificate request message, wherein the second certificate response message comprises a second certificate generated by a second secure enclave and a second digital signature generated by the second secure enclave for authenticating the second certificate; and
after transmitting the second certificate response message, receiving from the endpoint a model information request message, wherein
the first certificate request message is transmitted to the endpoint in response to receiving the model information request message.

31. A network node for enabling a model trainer to train an ensemble of models comprising a first model and a second model, the network comprising:
a transmitter;
a receiver; and
processing circuitry, wherein the network node is configured to perform a method comprising:
receiving from a first remote party a first certificate request message;
transmitting a first certificate response message responsive to the first certificate request message, wherein the first certificate response message comprises a certificate generated by a secure enclave in which the model trainer runs and a digital signature generated by the secure enclave for authenticating the certificate;
after transmitting the first certificate response message, receiving a first model information message transmitted by the first remote party, the first model information message comprising information pertaining to the first model;
receiving from a second remote party a second certificate request message;
transmitting a second certificate response message responsive to the second certificate request message, wherein the second certificate response message comprises the certificate generated by the secure enclave and the digital signature generated by the secure enclave; and
after transmitting the second certificate response message, receiving a second model information message transmitted by the second remote party, the second model information message comprising information pertaining to the second model.

32. The network node of claim 31, wherein the process further comprises:
providing to the model trainer the information pertaining to the first model; and
providing to the model trainer the information pertaining to the second model.

33. The network node of claim 32, wherein the model trainer uses the information pertaining to the first model and the information pertaining to the second model to train the first model and the second model.

34. The network node of claim 33, wherein the trained first model is provided to the first remote party.

35. The network node of claim 33, wherein the trained second model is provided to the second remote party.

36. The network node of claim 31, wherein the process further comprises:
prior to receiving the first certificate request message, receiving from a session manager a session initiation message comprising a session identifier; and
in response to receiving the session initiation message, creating the model trainer to run within the secure enclave.

37. (canceled)

38. The network node of claim 31, wherein the process further comprises:
after receiving the first certificate request message and before transmitting the first certificate response message, obtaining the certificate from the model trainer.
